(19) United States
(12) Patent Application Publication
(10) Pub. No.: US 2022/0284527 A1
(43) Pub. Date: Sep. 8, 2022

(54) Asset Documentation and Notification System

(71) Applicant: Cheri Williams-Franklin, Chicago, IL (US)

(72) Inventor: Cheri Williams-Franklin, Chicago, IL (US)

(21) Appl. No.: 17/249,527

(22) Filed: Mar. 4, 2021

(51) Int. Cl. G06Q 50/18; G06F 16/34; G06F 21/62; G06F 21/60; G06F 3/0482

(52) U.S. Cl. CPC G06Q 50/186; G06F 16/345; G06F 21/6218; G06F 21/602; G06F 3/0482

(57) ABSTRACT

A computer based asset management system that organizes and stores a member's end of life wishes. The users give information about their wishes and assets, and also designate designees. This is organized by guiding the first member through determining the different categories of assets that the first member owns, and receiving from the first member, information about each of the assets, and also receiving from the first member, the end of life information including asset evidencing documents, which indicate information about the assets owned by the member, and preferences regarding end of life wishes. Each asset document is associated with a permission level associated with the asset document, where the permission level includes at least a shared document which is immediately shared with the designee, and a personal document which is not shared with the designee, the system providing all the end of life information including the personal document which is not shared with the designee, until detecting a life changing event of the member.

### BACKGROUND

End-of-life is a challenging topic to discuss, let alone plan for. An unexpected event can catch family members off guard, with no easy way to figure out the financial issues or final wishes of the deceased.

A conventional way of people keeping track of their assets involve storing physical asset documents in a storage area and verbally informing persons about the existence of these documents. This yields a concern that the information can be lost, misplaced or forgotten, and can become difficult to retrieve.

People have the option to utilize google drive or alternative online storage vaults to maintain records.

Companies offer options including the following. Prisidio offers an online storage vault, but does not consolidate information into a single-sharable report. Everplans consolidates some information into a custom report, however does not offer a simple personalized end-of-life planning experience.

In essence, these companies offer document storage, but not an organized system for sharing among members/non-members.

### SUMMARY

The inventor recognized that there is no current solution that provides an adequate and organized way of obtaining and organizing end of life wishes and documents; securing the information and providing this information to desired designees.

An embodiment guides users through a personalized end-of-life planning experience, by organizing the various assets, final wishes, and copies of critical documents, and creating a single-sharable report that is sharable with designees.

An embodiment is referred to as a “Life Snapshot” system.

An embodiment describes how wellbeing checks can be periodically carried out.

In the event a member becomes incapacitated or has departed, the custom report, along with any uploaded documents—such as an advance directive, power-of-attorney, insurance policies, wills, succession plans, and more, can be shared with designated contacts, such as loved ones.

The custom report becomes a simple roadmap for families.

In embodiments, the platform offers complete privacy of information up until it is necessary to share—without the need for social security numbers or financial account numbers.

### BRIEF DESCRIPTION OF THE DRAWINGS

FIG. 1 shows a block diagram of the basic system;

FIG. 2 shows a flowchart of operation;

FIG. 3 shows a summary screen of the information obtained;

FIG. 4 shows a getting started screen;

FIG. 5 shows a summary flowchart of operation

FIG. 6 shows permissions for a customer/member and the primary admin; and

FIG. 7 shows permissions for a secondary admin.

### DETAILED DESCRIPTION

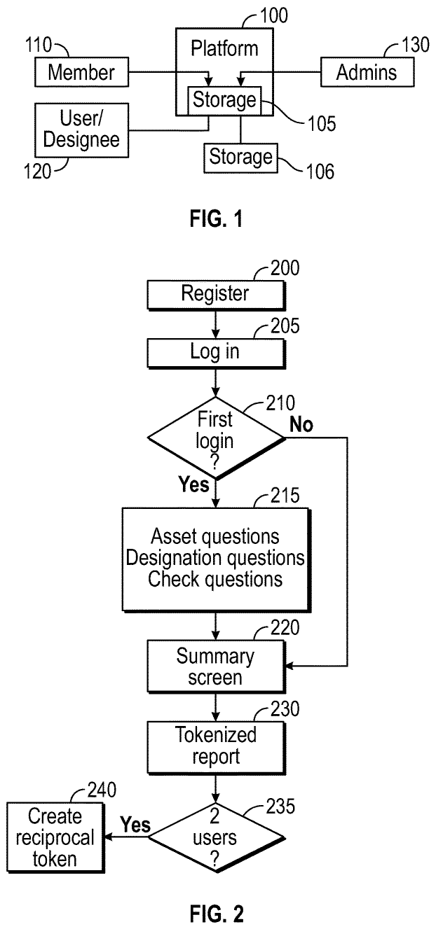

The basic system is shown in the block diagram of FIG. 1, in which the platform 100 is connected to communicate with a number of different parties, each of which preferably communicate with the platform via their own “client” computer.

The platform communicates with members 110. The “members” are the people documenting their assets, by uploading information such as information about their end of life wishes, and asset evidencing documents.

The platform also communicates with users or designees shown as 120 who are the people designated by the members to receive information about the members' assets.

The term “assets” as used herein generically to refer to any information shared by the member, that is desired to be shared with other people upon incapacity or death of the member. The term “asset evidencing documents” means any document referring to and evidencing assets or final wishes of the user. The end of life information include the assets, documents evidencing the assets, and any instructions or information from a member regarding their end of life wishes. The information is made available to the designees when there is a life changing event of the member, e.g., death, incapacity or other life changing event.

The platform also communicates with administrators shown as 130.

Each of the member, user and administrator is understood to have their own computer which is connected to the platform 100. Each of the parties can be on any kind of computing device that can access the internet, e.g., tablet, phone or desktop or laptop computer.

In one embodiment, the platform 100 can be a server, programmed to run software as described herein. The platform also includes a storage mechanism shown as 105, which can also include off-site storage shown as 106. The platform, and all of the storage is protected by encryption as described herein, using techniques that allow decryption of the information when necessary.

The platform is programmed according to the techniques described herein.

In an embodiment, part of the operations are carried out on a cloud server, with SSL security. The cloud server may carry out daily system backups, and use database encryption and malware scans to store and secure all the content. The web application interacts with the cloud server, using HTML, CSS, JavaScript, jQuery, and bootstraps for its front end, and code igniter for its backend. PHP and MySQL are used for the database 105, 106.

In operation, the platform operates to cause the actions discussed herein.

FIG. 2 illustrates an overall flow diagram of the operation. The member 110 initially registers for the service at 200, which includes obtaining some initial information from the user, and the user arranging for the payment. At this point, the user would typically set their login and password and set up security, such as two factor authentication. After the initial registration at 200, the user logs in at 205, to carry out any of the operations discussed herein.

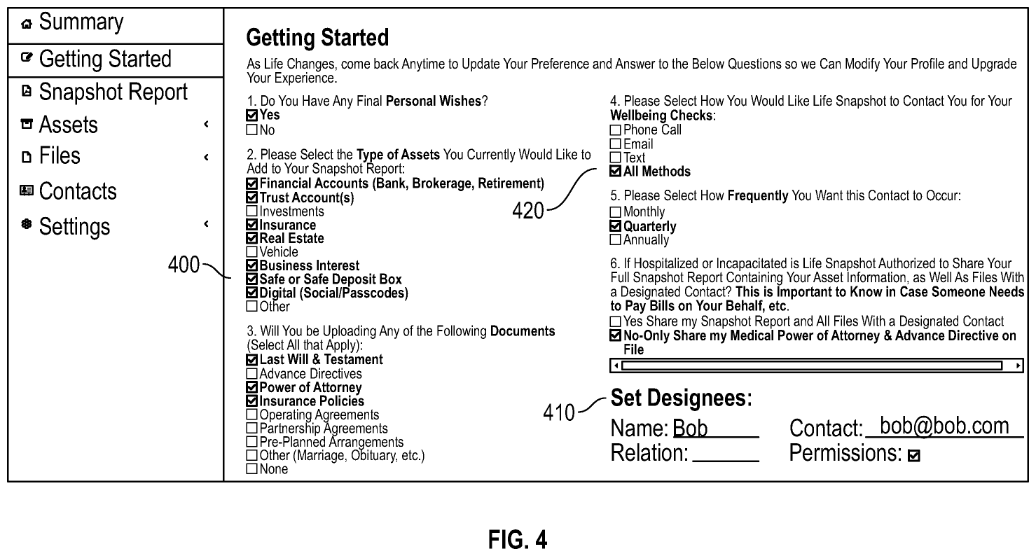

If the first login is detected at 210, then the user receives a ‘getting started’ screen, which shares information on the primary 3 “onboarding” steps. FIG. 4 illustrates this screen. The 3 onboarding steps include asset questions 400, designation questions 410 (designating the people who will receive information from the user) and well-being check questions 520. The user can set some or all of the operations during the initial login, and can set other operations during subsequent logins. As described herein, when a user logs in, they receive a bar graph indicating how much of the end of life information they have completed.

The system asks if the user has final wishes, (and if so, asks about the final wishes later on as part of populating this).

Then, the user is asked about in general the categories of assets that are owned by the user.

The asset questions provide different category of assets, to help the user organize the different assets that they have. Each of the assets is shown via a checkbox, and when the user checks off one of the checkboxes, it indicates that they have assets of that particular class.

These asset categories can include, as shown in FIG. 4, financial accounts, trust accounts, investments, insurance, real estate, vehicles, business interests, safe deposit box or other assets.

The user is also asked about documents that they have including a last will and testament, advanced directives, power of attorney, insurance policies, operating agreements, partnership agreements, arrangements, and marriages.

The user is asked to choose their designated contact. This takes the name, relationship, and contact information for the designated contact(s), who is the person who will be contacted in the event of incapacity of the user. The designated contacts become users of the system in that they can get information from the system (based on what the member allows), but cannot change the preferences. The user is asked for permissions for the designee if they become incapacitated: if they want to share their snapshot report and all files with designated contact, or if only share the advance directive or medical power of attorney with the designated contact.

The system also determines well-being check preferences 420. This tells the system how to check on the user. It allows the user to enter contact information to be used for the well-being checks, and the desired frequency of well-being checks. Wellbeing check frequency can occur monthly, quarterly, or annually based on user preference. The user is asked about how to conduct the well-being checks e.g. by phone call, text, email, and the frequency of the well-being communication. The system will escalate well-being concerns and contact designated contacts if the user does not respond to the wellbeing check within a predetermined amount of time based on the user's frequency preference.

Other conventional profile information such as security questions, name, address, date of birth, and other information can also be gathered.

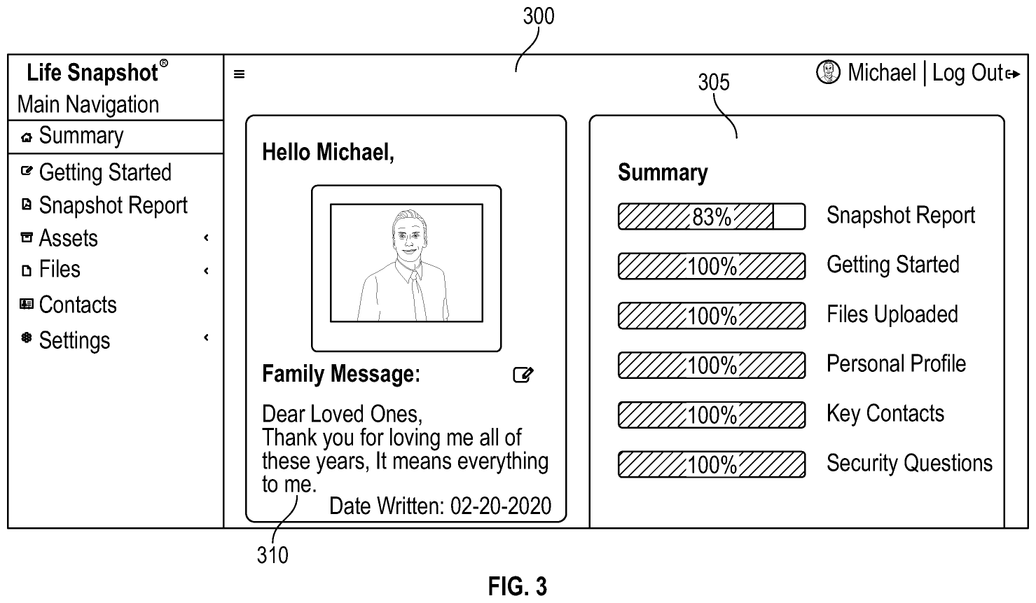

The information that is gathered is used to create one or more summaries. A status summary screen 300 is shown in FIG. 3. After the initial information is gathered, and/or at subsequent logins to the system, this status summary screen is displayed to the user to help the user make sure that their information is either up-to-date or at least give the user some guidance about what additional information that they need to add to the system.

The status summary report tells the user different information about how much of the system that the user has set up. This includes a summary bar graph, 305 which shows for each of a plurality of different categories, how much of the category is set up. For example, the categories can indicate the snapshot report, getting started, files that are uploaded, personal information, key contacts, and security questions. The status summary also provides a message to the family at 310, providing information about all of the assets.

For example, if the user has selected certain categories of information, then the users progress in entering this information will be shown in the bar graphs.

This thereby enables the user to see how much more information they still need to enter. The summary screen also shows information that assist the user in sharing this and their information with others including the member ID, email, and family message section 310 that provides a final message to the family members. The summary screen is also visible to the system administrators or customer service team so that if a user's designated contacts request information, they can notify them of the user's completion status for the various categories within the system.

At any point, the user can edit and enter new answers or adjust their answers. For each kind of asset, the user is asked to upload documents that support those assets.

The system can also create a snapshot report that provides a consolidated view of the information that the user has input under their assets, final wishes, family message, files and contacts. This snapshot report also lists the documents that were uploaded, the date stamp in which the documents were uploaded, and all information that been entered.

A point of this system is to allow the member to provide documentation of all the information that the designees might need in case of the user's unavailability for any reason.

An important category of this information is the document information. The documents can be uploaded to the system and provide documentation which is provided to the designee to assist the designee in finding the documentation.

The filesharing of the present system allows members to provide documents that can be used and seen by others, e.g., designees. The members can assign privileges to designees, to allow these designees to receive access to the member's files.

There are also various kinds of advanced assigning privileges. For example, in an embodiment, if two members sign up separately but assign one another as designated contacts, then the system automatically links those two users and enables filesharing between their accounts. Both members' private portals remain private. For example, Member B may have an Advance Directive file that they want to share with Member A. The only way Member B can see the Advance Directive file is if Member A shares that Advance Directive, so that the advance directive appears in Member B's private Received Documents screen. In general, however, there is no visibility between Members accounts without user designating permission.

There are three basic filesharing types according to the present system.

Personal documents are all the uploaded user documents and files from a member.

Shared documents show the files that the user shared with another member or nonmember. Members can designate documents to be shared with either another member or with the nonmember (a designee). The documents shared by a member shows under the shared documents section.

Received documents screen shows files that have been received by another member. The documents shared by a member become received documents to the party designated by the member. This screen will only show content if two members share files with one another. A non-member cannot share a file with a member. The member would need to receive that document outside the embodiment and upload it under their Personal Documents section.

Members can share their uploaded documents with the nonmember by emailing them from within the platform and giving the designee a private link. Anytime the member updates the file, the nonmember can automatically access that link and see the latest version of the file.

The accuracy of the filesharing process is crucial, because after the life changing event of the member, there is no way to correct any mistakes that have been made. These files often actually represent the user's assets, and may provide the information that allows the designee to find these assets.

In an embodiment, members can update shared files, that can only be seen by those with permissions. The system maintains the secrecy of these uploaded files, using its secure system. In an embodiment, the files are secure against anyone who has not been given access to the files, including customer service representatives. The customer service representatives cannot see the member's documents. The member on the other hand, can share the document, and can sync the document directly with a designee.

The member can also elect to keep these documents secret until the life changing event of the member, at which time the system administrator shares all designated files with the designees.

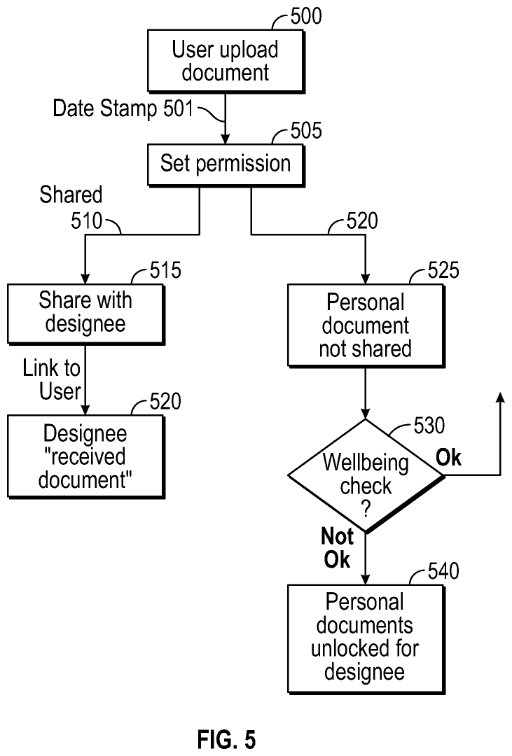

The filesharing proceeds according to the flowchart of FIG. 5, which is carried out by the platform 100, The filesharing may be carried out as part of the operations of 215 in which the assets are being organized. As part of the asset organization, at 500, the user uploads document(s). A date stamp is added at 501 indicating when each file was uploaded. The date stamp allows the designees to know how recently a file was added to the platform so that they can determine age of the file.

At 505, the user sets the permission of this document. The document can be shared, at 510, in which case the document is shared with the designee at 515. This can be either provided into the designee's shared document or received into the document inbox at 520. Alternately, the sharing can be carried out by providing a link to the user which can be selected by the user to allow the user access to the document.

The shared documents are immediately accessible to the designee. Any time that the member updates this document, for example if they update an insurance policy, the new version of the document which has been updated by the member can be seen by the nonmember designee via the previously shared link. Only the designees can see these documents. Customer service reps are unable to see the content within the members' documents.

A personal document is maintained completely secret against anyone except the member and the designees. The personal document at 525 is stored in the platform, but is not shared with anyone, until an event occurs. Designees can not see personal document content until an event occurs.

At 530, the system carries out its periodic well-being checks. If the well-being check finds that the user is healthy, then no changes are made. However, if the well-being check finds that the user has changed status to unavailable, then the personal documents associated with the new state of the user are unlocked for the designee at 540.

The well-being checks can occur for example monthly, quarterly or annually. The user is contacted during the well-being check. After a predetermined time with no response from the member to the well-being check, then additional actions are taken to determine the status of the user, e.g., phone calls, or personal checks and/or one or more of the designated contacts are contacted.

For these personal documents, customer service reps are unable to see the documents, and designees cannot see the documents until the well-being check comes back as indicating that the member's status has changed. This provides a maximum amount of security for these personal documents.

This secrecy becomes important for example for issues having to do with disabilities or with other medical conditions that may be subject to HIPPA. The files at that point become designated during the user's lifetime making it impossible to get this wrong.

The system creates at 230, a tokenized report for the member containing all of the end of life planning information in a digital file. The digital file, for example can be a single snapshot report which can be downloaded into a PDF, printed or shared electronically. This report is created by the platform which consolidates answers to the various questions about asset information, final wishes, and critical documents.

In one embodiment, the digital files that were created by the system are encrypted by a token. The token is owned by the member, and so consequently the contents of the digital file which are encrypted with that token can only be viewed by the member. The member uses the token data to launch the actions to change the file. As in other embodiments, no user can see the file unless they have been given permission. No customer service rep can see the contents of the file.

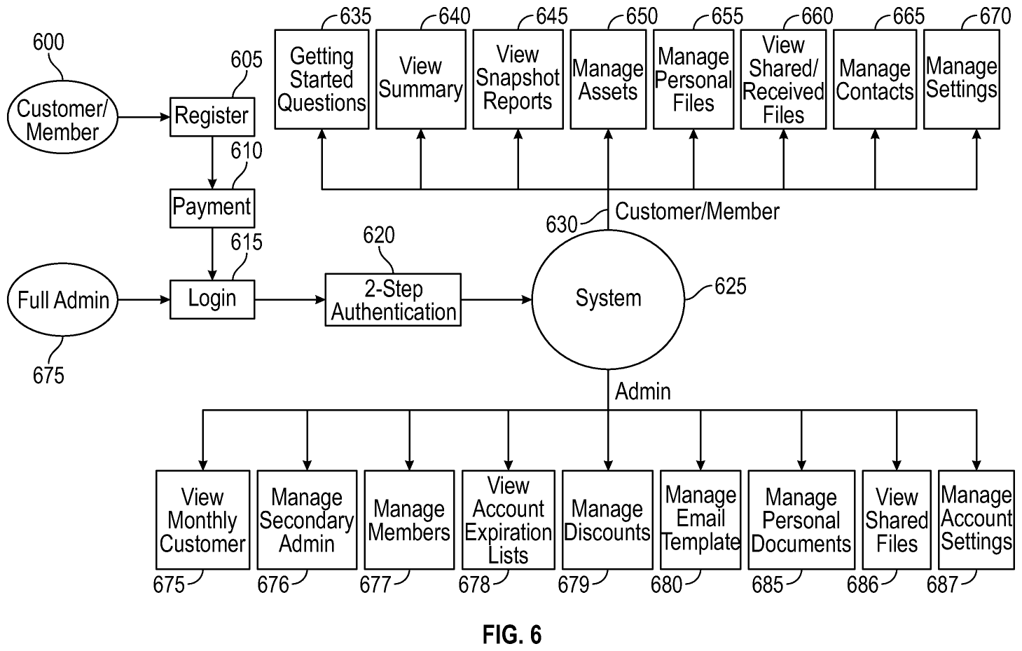

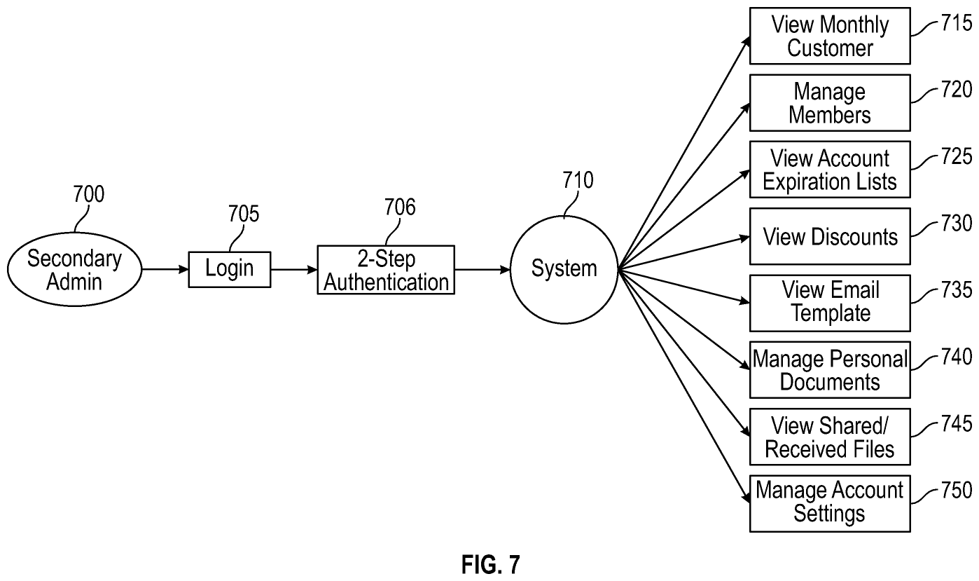

The permissions are set by the system as shown in FIGS. 6 and 7, which show backend interfaces of the customer view, the full admin view and the secondary admin view. Each of these permission levels has varying permission sets.

In FIG. 6, the customer/member at 600 can register at 605, and provide payment at 610, as part of the initial operation. During subsequent operations, the customer/member can log in at 615. This requires a two step authentication operation 620, which provides access to the system. The customer/member receives the access shown as 630, which provides getting started questions 635, the summary 640, snapshot reports 645, managing assets 650, managing personal files 655, viewing shared and received files 660, managing context 665 and managing settings at 670. Customers have full visibility to the various customer screens and can see all of the contents within their own asset section, snapshot report, and documents.

The full admin view allows the full admin to log in at 615 and carries out a 2 step authentication at 620, to receive access to the system at 625. The full admin is given various accesses as described herein, however does not have visibility to the member's snapshot, as described herein, the single report that contains the consolidated asset report, does not have access to the final wishes of the members, or lists of files that have been uploaded by the members. That is, the admin does not get visibility to the content documents. Since the admin does not have visibility to these documents, the admin cannot download these, or send them to another user.

The full admin does get access to monthly customer reports at 675, can manage the secondary admins at 676, manage members at 677, view the account expiration lists at 678, manage discounts at 679, manage email templates at 680, manage personal documents at 685, view shared files at 686, and manage account settings at 687.

The secondary admin view is shown in FIG. 7. The secondary admin gets varying permission sets, and in general will have less permissions than the full admin. The full admin receives some permissions that the secondary admin does not receive at all, and the full admin receives managing permissions of some types where the secondary admin receives only as viewing permissions.

At 700 the secondary admin logs in at 705, carries out 2 step authentication at 706, and receives access to the system at 710. Once receiving this access, the secondary admin can view the monthly customer lists 715, manage the members at 720, view the account expiration lists at 725, view discounts at 730, view email templates at 735, manage personal documents at 740, view received shared files at 745, and manage account settings at 750. In general, however, the permissions and operations of the secondary admin can be adjusted.

Members can designate designees to view their information in which case the data is decrypted and shared with designees. In this way, the designee receives decrypted files and a snapshot report when an event/action occurs. In one embodiment, the user can share their snapshot report with a designee, at any time. By automatically linking this to the users designated contact name and email address, this minimizes the possibility of order entry mistakes.

When two members assign each other as designated contacts at 235, then their accounts are automatically synced to share designated documents with one another. All files are completely private until one of the users grants permission access to a specific document. Complete privacy remains between one another. This causes the two members to each have reciprocal tokens shown at 240, that is tokens that can decrypt and allow viewing of each other's information with authorization by the user. As an example, a husband and wife can designate one another, and each account is automatically synced for file sharing. However, there is no visibility of one another's files without permission access given by the user. If two persons exist with a reciprocal token, their accounts are auto synced to share documents with one another; while maintaining complete privacy to parties other than one another with permission access granted for a particular file. There is no visibility between each user's accounts—the users cannot see the content contained in the other users Asset section, Snapshot Report, or Documents. However, they have the option to automatically share files with one another. Any documents shared between users will show up in the users Received Document Screen.

Upon a serious injury or death of the member, the built in programming languages has functionalities to decrypt data from the cloud server so the snapshot report, files and documents are easily shared with designee.

The admin cannot download the Snapshot Report nor any of the documents to their personal computer. The admin cannot physically type in a different email address and send the Snapshot Reports or documents to an outside email address.

The users Snapshot Report and Files are automatically linked to the users Designated contacts name and email addresses so there are no order entry mistakes. It also prevents customer service agents from unauthorized access to members information.

In the event a member is incapacitated or has reached end-of-life, this Summary will allow customer support to communicate if the user fully completed their Snapshot Report and Uploaded all files. This is important because if these bars are not at 100% then customer support will need to let designated contacts know that information is missing so the family may need to look for some additional documents in this case. In the event that the member becomes incapacitated, the administrator has the ability to provide an unencrypted file to the designee on behalf of the user.

Although only a few embodiments have been disclosed in detail above, other embodiments are possible and the inventors intend these to be encompassed within this specification. The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An end of life wishes management system, comprising:
a computer, programmed to store information in a storage unit, and programmed to communicate with users of the end of life wishes management system,
users of the end of life wishes management system including members of the end of life wishes management system who are providing information about their end of life information to the computer,
users of the end of life wishes management system also including designees of the asset management system who are designated by the members to receive some or all of the end of life information of the member,
the computer operating to obtain the end of life information from a first member, and to organize the information from the first member,
including, for the first member, to display a plurality of different helping screens to the first member, guiding the first member through determining the different categories of assets that the first member owns, and receiving from the first member, information about each of said assets,
and also receiving from the first member, the end of life information including asset evidencing documents, which indicate information about the assets owned by the member, and preferences regarding end of life wishes,
and for each asset document, receiving a permission level associated with the asset document, where the permission level includes at least a shared document which is immediately shared with the designee, and a personal document which is not shared with the designee,
the system providing all the end of life information including the personal document which is not shared with the designee, based on detecting a life changing event of the member.

2. The system as in claim 1, wherein the life-changing event is a death of the member.

3. The system as in claim one, wherein the life-changing event is an incapacity of the member.

4. The system as in claim 1, further comprising the computer carrying out a well-being check of the member, at intervals selected by the member, and using results of the well-being check to determine if the life changing event has occurred.

5. The system as in claim 1, wherein the personal documents are stored encrypted, and are decrypted when the life changing event has been determined to occur.

6. The system as in claim 1, further comprising the computer system creating a personal report summarizing all of the different documents which are available on the system.

7. The system as in claim 6, wherein the personal report is encrypted using the token, so that only the member can view the personal report, and other members and customer service representatives cannot view the personal report, and the personal report can be decrypted by the programming language based on the life-changing event.

8. The system as in claim 5, further comprising detecting two users designating one another, and creating a token that is reciprocal for the two users.

9. The system as in claim 1, further comprising displaying to the member, when the member enters the system, a bar graph indicating percentages of different end of life information which have been fully completed by the member.

10. The system as in claim 1, wherein the information from the members includes asset questions, final wishes questions, designation questions, and wellbeing check questions.
